(19) United States
(12) Patent Application Publication
(10) Pub. No.: US 2004/0174711 A1
(43) Pub. Date: Sep. 9, 2004

(54) Table lamp with thermal insulting disk

(76) Inventor: Wen-Chang Wu, Chang hua (TW)

Correspondence Address: Wen-Chang Wu, 235 Chung-Ho, Box 8-24, Taipei, TW

(21) Appl. No.: 10/378,111

(22) Filed: Mar. 4, 2003

(51) Int. Cl. F21S 8/08

(52) U.S. Cl. 362/414

(57) ABSTRACT

A table lamp with a thermal insulting disk comprises a table lamp; a lamp seat extending from a lower side of the table lamp; a thermal insulting disk installed on the lamp seat. When reading, a cup with beverage therein can be placed on the thermal insulting disk aside the table lamp; thereby when reading, one can read and drinks the beverage in the cup.

### BACKGROUND OF THE INVENTION

The present invention relates to table lamps, and particularly to a table lamp with a thermal insulting disk which comprises a table lamp; a lamp seat extending from a lower side of the table lamp; a thermal insulting disk installed on the lamp seat.

Generally, peoples like to drink a cup of coffee or milk when reading or performing official business. Especially, in winter, a cup of hot beverage will make the drinker feel worm and pleasant.

Conventionally, the table lamp only has function of illumination. When one sits aside the table lamp, to drink a cup of beverage rises a good feeling to the drinker, especially, in winter, but the beverage often becomes cold before all the beverage has been drunk. However in many cases, the drinker will stop drinking the beverage. Thereby, if the table lamp is incorporated with a thermal insulting disk which can warm the beverage will make those aside the table lamp feel comfortable.

### SUMMARY OF THE INVENTION

Accordingly, the primary object of the present invention is to provide a table lamp with a thermal insulting disk which comprises a table lamp; a lamp seat extending from a lower side of the table lamp; a thermal insulting disk installed on the lamp seat. When reading, a cup with beverage therein can be placed on the thermal insulting disk aside the table lamp; thereby when reading, one can read and drink the beverage in the cup.

The various objects and advantages of the present invention will be more readily understood from the following detailed description when read in conjunction with the appended drawing.

### BRIEF DESCRIPTION OF THE DRAWINGS

FIG. 1 is a plane view of the present invention.

FIG. 2A shows one embodiment of the present invention, where a cup of beverage is placed on the table lamp.

FIG. 2A shows another embodiment of the present invention, where a cup of beverage is placed on the table lamp.

### BRIEF DESCRIPTION OF THE PREFERRED EMBODIMENTS

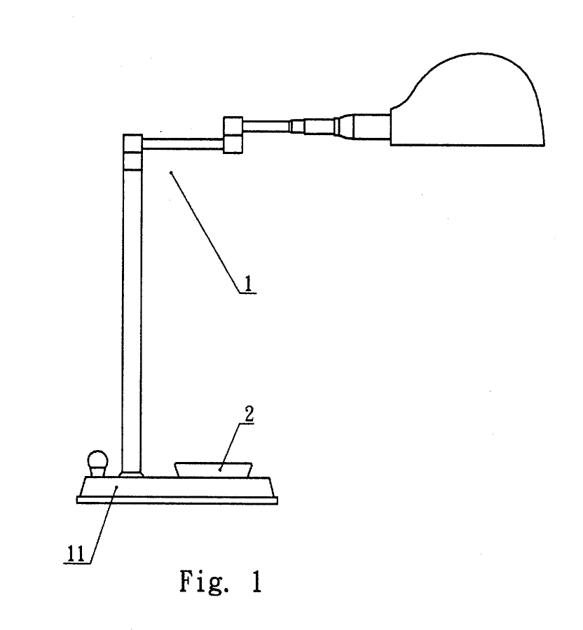

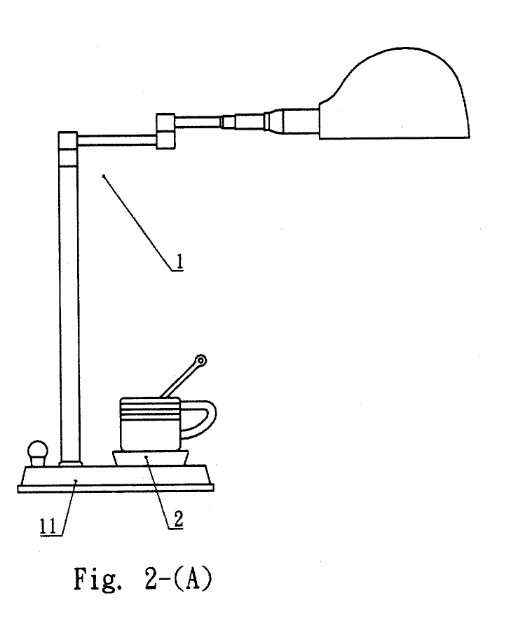

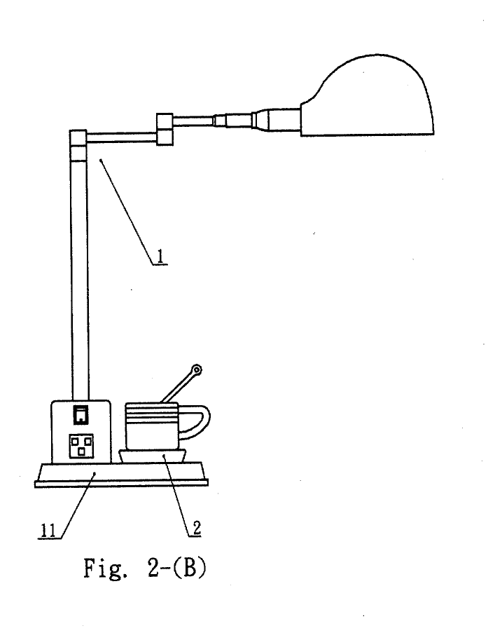

Referring to FIGS. 1, 2A and 2B, the structure of the present invention is illustrated. In the present invention, a thermal insulting disk 2 is attached to a table lamp 1. A lower side of the table lamp 1 is extended with a lamp seat 11. A thermal insulting disk 2 is installed on the lamp seat 11. Thereby, when reading, a cup, of beverage, such as coffee, or milk can be placed on the thermal insulting disk 2 aside the table lamp 1 so that the coffee or milk can retained in hot condition, as shown in FIGS. 2A and 2B. Thereby, user can drink it as desired.

Therefore, a table lamp with a thermal insulting disk for retaining the temperature of the cup having beverage therein is formed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A table lamp with a thermal insulting disk comprising
a table lamp
a lamp seat extending from a lower side of the table lamp;
a thermal insulting disk installed on the lamp seat;
wherein, when reading, a cup with beverage therein can be placed on the thermal insulting disk aside the table lamp; thereby when reading, one can read and drinks the beverage in the cup.
